(19) United States
(12) Patent Application Publication
(10) Pub. No.: US 2011/0256790 A1
(43) Pub. Date: Oct. 20, 2011

(54) THERMAL INSULATION CONTAINING SUPPLEMENTAL INFRARED RADIATION ABSORBING MATERIAL

(75) Inventors: Murray S. Toas, Norristown, PA (US); Kurt Mankell, Blue Bell, PA (US); Alain Yang, Bryn Mawr, PA (US); Kevin Gallagher, Plymouth Meeting, PA (US); Dave Ober, Doylestown, PA (US); Gary Tripp, Corbin, KY (US); Eladio Montoya, Paris (FR); Jean-Luc Bernard, Breuil le Vert (FR)

(73) Assignee: SAINT-GOBAIN ISOVER, Courbevoie (FR)

(21) Appl. No.: 13/079,631

(22) Filed: Apr. 4, 2011

Related U.S. Application Data
(63) Continuation of application No. 10/477,996, filed on Aug. 30, 2004, now abandoned.
Application No. 10/477,996 is a continuation-in-part of application No. 09/858,471, filed on May 17, 2001, now abandoned.

(51) Int. Cl. E04B 1/78; B29C 69/00; D04H 13/00

(52) U.S. Cl. 442/327; 252/62; 264/171.26

(57) ABSTRACT

A thermal insulation product includes an infrared radiation absorbing and scattering material dispersed on fibers forming a porous structure. The infrared absorbing and scattering material can include borate compounds, carbonate compounds, and alumina compounds.

### BACKGROUND OF THE INVENTION

1. Field of the Invention

This invention relates to thermal insulation. More specifically, this invention relates to thermal insulation containing infrared radiation (“IR”) absorbing and scattering material, which reduces radiative heat transfer through the thermal insulation.

2. Description of Related Art

Heat passes between two surfaces having different temperatures by three mechanisms: convection, conduction and radiation. These heat transfer mechanisms are combined in a quantitative measure of heat transfer known as “apparent thermal conductivity.”

Insertion of glass fiber thermal insulation in the gap between two surfaces reduces convection as a heat transport mechanism because the insulation slows or stops the circulation of air. Heat transfer by conduction through the glass fiber of the insulation is also minimal. However, many glass compositions used in glass fiber insulation products are transparent in portions of the infrared spectrum. Thus, even when the gap between surfaces has been filled with glass fiber thermal insulation, radiation remains as a significant heat transfer mechanism. Typically, radiation can account for 10 to 40% of the heat transferred between surfaces at room (e.g., 24° C.) temperature.

Fiber to fiber radiative heat transfer is due to absorption, emission and scattering. The amount of radiative heat transfer between fibers due to emission and absorption is dependent on the difference in fiber temperatures, with each fiber temperature taken to the fourth power.

To reduce radiative heat loss through thermal insulation, a number of approaches have been considered.

U.S. Pat. No. 2,134,340 discloses that multiple reflections of infrared radiation from a powder of an infrared transparent salt, such as calcium fluoride, added to glass fiber insulation can prevent the infrared radiation from penetrating any substantial distance into the insulation.

U.S. Pat. No. 5,633,077 discloses that an insulating material combining certain chiral polymers with fibers can block the passage of infrared radiation through the insulating material.

U.S. Pat. No. 5,932,449 discloses that glass fiber compositions displaying decreased far infrared radiation transmission may be produced from soda-lime borosilicate glasses having a high boron oxide content and a low concentration of alkaline earth metal oxides.

There remains a need for a cost effective thermal insulation product that can reduce radiative heat loss.

### SUMMARY OF THE INVENTION

A thermal insulation product is provided in which an IR absorbing and scattering material is dispersed on fibers arranged in a porous structure. The IR absorbing and scattering material can be applied to the fibers before or after the fibers are formed into the porous structure. The IR absorbing and scattering material substantially reduces the radiative heat loss through the thermal insulation. Inclusion of the IR absorbing and scattering material improves the effective wavelength range over which the porous structure absorbs infrared radiation and improves its overall extinction efficiency. The IR absorbing and scattering material is about as effective as glass fiber in reducing radiative heat loss through a porous fiber structure, but can be much less expensive than glass fiber. Hence, the IR absorbing and scattering material can provide a cost-effective means of improving thermal insulation.

### BRIEF DESCRIPTION OF THE DRAWINGS

The preferred embodiments of the invention will be described in detail, with reference to the following figures, wherein:

FIG. 1 shows the absorption spectra of silica, glass fiber, calcium carbonate and borax;

FIG. 2 shows a method of applying IR absorbing and scattering material to fibers;

FIG. 3 shows a method of adding IR absorbing and scattering material to an unbonded glass fiber mat;

FIG. 4 shows a method of applying IR absorbing and scattering material to fibers including recycled fiberglass; and

FIG. 5 shows a method of applying IR absorbing and scattering material to fibers.

FIG. 6 shows a method of forming pipe insulation by wrapping an insulation mat around a mandrel.

### DETAILED DESCRIPTION OF PREFERRED EMBODIMENTS

The present invention reduces the radiant transmission of heat through a fiber based thermal insulation product by dispersing an IR absorbing and scattering material onto the fibers. Because the IR absorbing and scattering material can be less expensive than the fiber, the substitution of the IR absorbing and scattering material for some of the fiber can lead to a significant cost reduction in thermal insulation.

A suitable IR absorbing and scattering material absorbs and scatters infrared radiation with a wavelength in the 4 to 40 μm range. Preferably, the IR absorbing and scattering material absorbs 6-8 μm (1667-1250 cm⁻¹) infrared radiation. The IR absorbing and scattering material can include borate compounds, carbonate compounds, alumina compounds, nitrate compounds and nitrite compounds. These compounds can be alkali metal salts or alkaline earth metal salts. Borate compounds, carbonate compounds and alumina compounds are preferred. Suitable borates include lithium borate, sodium borate, potassium borate, magnesium borate, calcium borate, strontium borate and barium borate. Preferably, the borate is sodium borate (i.e., borax, Na₂B₄O₅(OH)₄.8H₂O or Na₂B₄O₇.10H₂O) or colemanite (Ca₂B₆O₁₁.5H₂O). Suitable carbonates include lithium carbonate, sodium carbonate, potassium carbonate, calcium carbonate (i.e., calcite, CaCO₃), dolomite (CaMg(CO₃)₂), magnesium carbonate (i.e., magnesite, MgCO₃), strontium carbonate and barium carbonate. Preferably, the carbonate is calcium carbonate, dolomite, or magnesite. Suitable alumina compounds include hydrated alumina (Al₂O₃.3H₂O or Al(OH)₃) and alumina (Al₂O₃). ALCOA produces HYDRAL and B-303 particles of hydrated alumina.

The infrared absorbing and scattering material is useful in improving the thermal resistance of a porous thermal insulation product containing fibers. In particular, carbonate compounds and alumina compounds are useful in improving the thermal resistance of porous thermal insulation containing fibers at temperatures of 300° C. or more or even 400° C. or more.

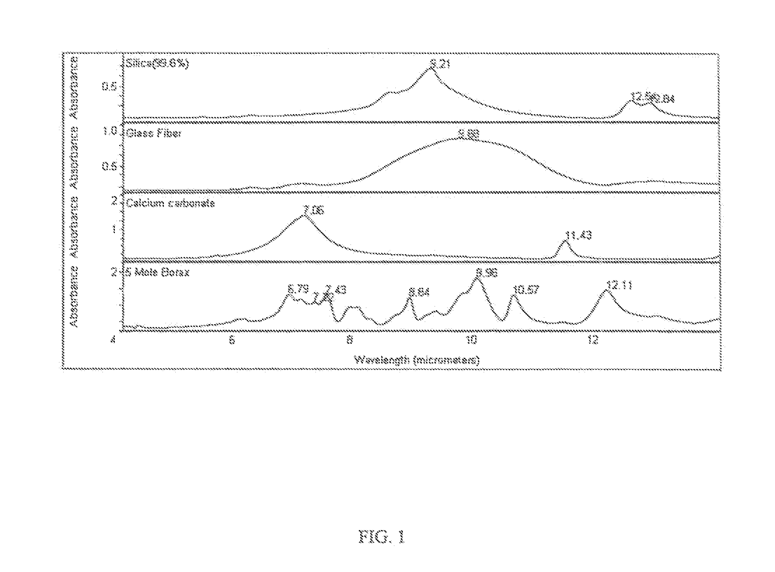

FIG. 1 shows the absorption spectra of borax and calcium carbonate. The absorption characteristics of borax and calcium carbonate complement those of glass fiber and silica, which have been used commercially in thermal insulation for over fifty years.

The amount of IR absorbing and scattering material in the thermal insulation product can range from 1 to 40 wt %, preferably from 2 to 30 wt %, more preferably from 4 to 20 wt %. If the amount of IR absorbing and scattering material is less than 1 wt %, then the reduction in radiative heat loss is negligible. If the amount of IR absorbing material is in excess of 40 wt %, then the IR absorbing and scattering material forms an undesirable amount of dust in the thermal insulation product.

The fibers in the thermal insulation product can be organic or inorganic. Organic fibers include cellulose fibers; cellulosic polymer fibers, such as rayon; thermoplastic polymer fibers, such as polyester; animal fibers, such as wool; and vegetable fibers, such as cotton. Preferably, the fibers are inorganic. Inorganic fibers include rock wool and glass wool. Preferably, the inorganic fibers comprise a glass.

The fibers form a porous structure. The porous structure can be woven or nonwoven. Preferably, the porous structure is nonwoven. The nonwoven fibers can be in the form of a batt, mat or blanket. A preferred porous structure is that found in FIBERGLASS.

Along with the fibers and IR absorbing and scattering material, the thermal insulation product can include a binder to capture and hold the fibers and IR absorbing material together. The binder can be a thermosetting polymer, a thermoplastic polymer, or an inorganic bonding agent. Preferably, the thermosetting polymer is a phenolic resin, such as a phenol-formaldehyde resin. The thermoplastic polymer will soften or flow upon heating to capture the fibers and IR absorbing and scattering material, and upon cooling and hardening will hold the fibers and IR absorbing and scattering material together. In embodiments of the present invention, the IR absorbing and scattering material can itself bond fibers together and thus render the addition of a binder unnecessary. When binder is used in the thermal insulation product, the amount of binder can be from 1 to 35 wt %, preferably from 3 to 30 wt %, more preferably from 4 to 25 wt %.

The thermal insulation product of the present invention can be formed by dispersing the IR absorbing and scattering material on to the surface of fibers, and by forming the fibers into a porous structure. The dispersed IR absorbing and scattering material can be in the form of particles. The optimum particle size is around 4 μm. Preferably 99% of the particles are less than 10 μm in size. The infrared absorbing and scattering material can be dispersed on the fibers before or at the same time or after the fibers are formed into the porous structure. Methods of forming fibers into porous structures are well known to the skilled artisan and will not be repeated here in detail.

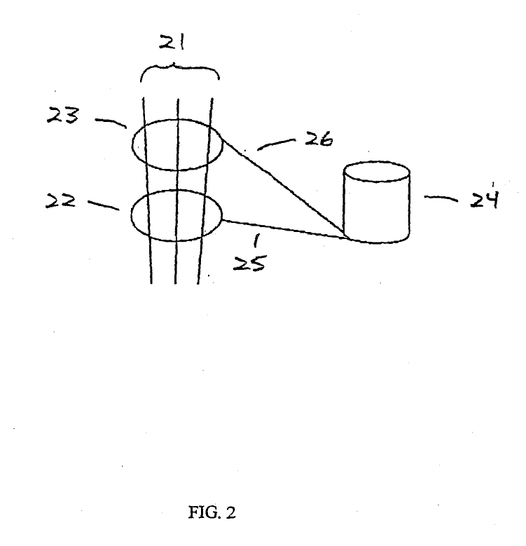

FIG. 2 shows a method of depositing IR absorbing and scattering material on glass fibers. Glass fibers 21 pass through a water overspray ring 23 and a binder application ring 22. Tank 24 is connected via lines 25 and 26 to rings 22 and 23, respectively. In tank 24 an IR absorbing and scattering material is dissolved or suspended in a liquid mixture. The IR absorbing and scattering material is applied to the glass fibers 21 by injecting the liquid mixture from tank 24 into the binder application ring 22 and/or the water overspray ring 23. The liquid mixture can include water and various surfactants and suspension agents. If the IR absorbing and scattering material is not completely dissolved in the liquid mixture, the liquid mixture must be agitated to keep the IR absorbing and scattering material in suspension. The spray nozzles in rings 22 and 23 have nozzle orifices large enough to permit undissolved IR absorbing and scattering materials to pass through the nozzles without clogging.

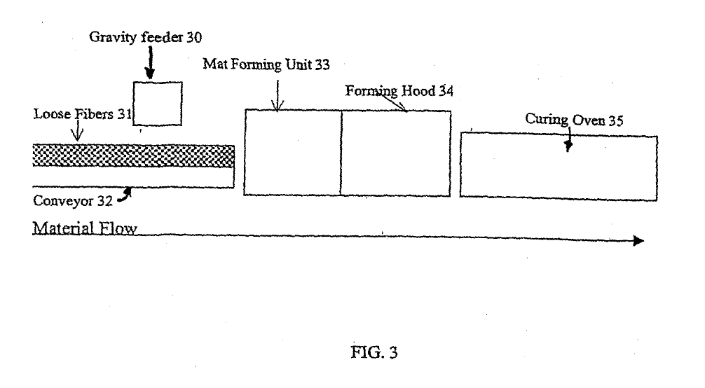

FIG. 3 shows an embodiment in which binder and IR absorbing and scattering material are dispersed from gravity feeder 30 on top of loose fibers 31 that have been distributed across the width of a conveyor 32 to form a porous mat. The IR absorbing and scattering material is introduced into the porous mat separately from or premixed with a binder. The binder can be a dry powder. The fibers with binder and IR absorbing and scattering material dispersed on the fibers then pass through a mat forming unit 33 where they are mixed and delivered into the air lay forming hood 34. The binder and IR absorbing and scattering material may also be added at the mat forming unit 33. The mix is then collected through negative pressure on another conveyor (not shown) and transported into a curing oven 15. When passed through curing oven 35, the binder melts, cures, and binds together the IR absorbing material and fiber.

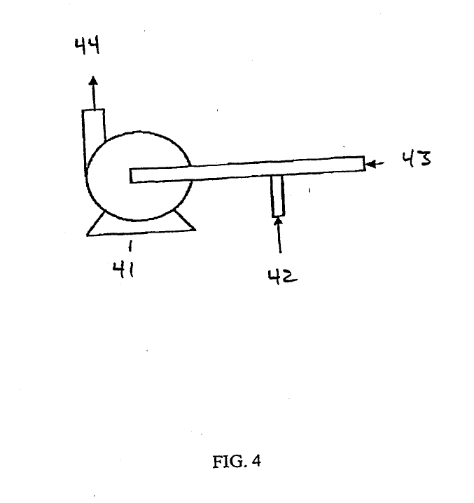

FIG. 4 shows an embodiment in which a recycling fan 41 is used to suck in and mix IR absorbing material (e.g., calcium carbonate powder) from fan intake 42 and recycled glass fiber from fan intake 43. The IR absorbing and scattering material and recycled glass fibers are blown from fan 41 at exit 44 into a forming hood (not shown). There the mixture is dispersed on glass fiber, together with a binder, if necessary. After passing through a curing oven (not shown) the IR absorbing and scattering material materials and glass fibers are bonded together.

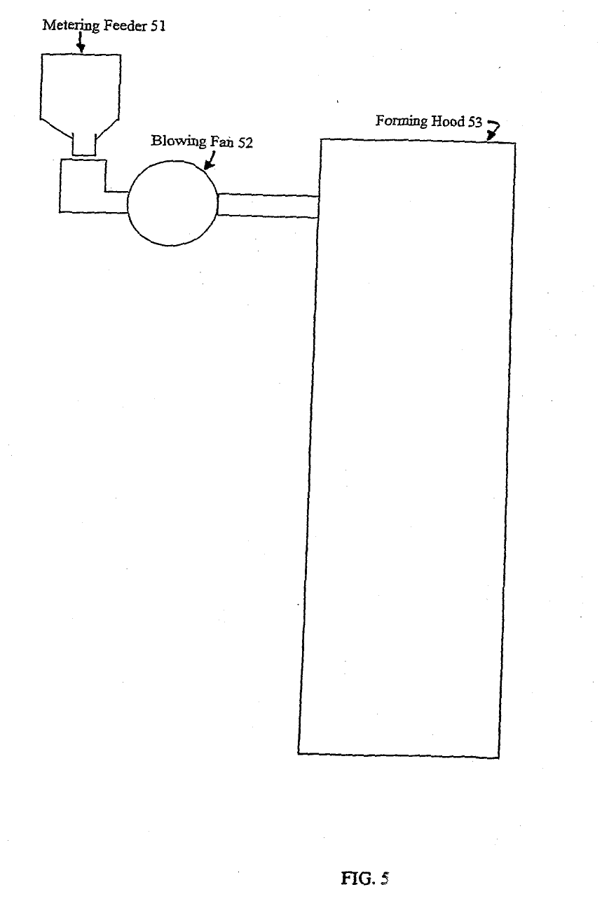

FIG. 5 shows an embodiment in which a metering feeder 51 feeds the dry, powder IR absorbing and scattering material into a blowing fan 52. The IR absorbing and scattering material is blown by the fan into the forming hood 53 and dispersed on glass fiber with a binder, if necessary. Multiple feeders and blowing fans may be used.

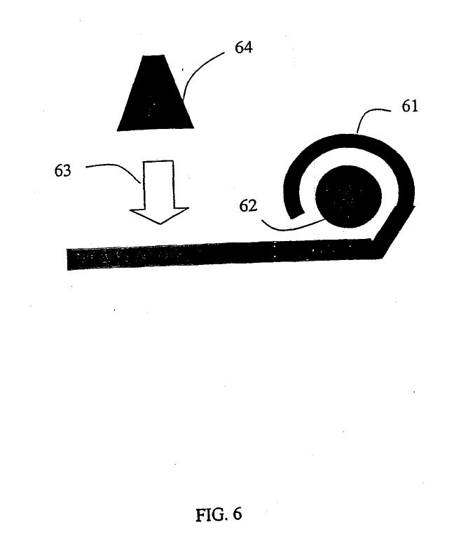

FIG. 6 shows embodiments in which thermal pipe insulation is produced by wrapping an insulation mat 61 around a hot mandrel or pipe 62 to form a section of pipe insulation having one or more layers of the insulation mat 61. Preferably the section of pipe insulation is cylindrical. Infrared absorbing and scattering material 63, in liquid or powder form, can be deposited by, e.g., spraying, onto the insulation mat 61 from a infrared absorbing and scattering material source 64 while the insulation mat 61 is on the mat production line and before the insulation mat 61 is wrapped around the mandrel 62. The infrared absorbing and scattering material preferably includes at least one carbonate or alumina compound.

### EXAMPLES

The following non-limiting examples will further illustrate the invention.

### Example 1

FIBERGLASS samples are prepared in a laboratory with either borax {Na₂B₄O₇.10H₂O} or calcium carbonate dispersed throughout as IR absorbing and scattering materials. The samples are 30.5 cm wide×30.5 cm long×2.5 cm thick. The IR absorbing materials are weighed and mixed in a solution of 30% isopropanol and 70% water. The borax is dissolved in the water using a mixer and a hot plate to form a borax solution. The calcium carbonate is mixed in the alcohol/water by hand to form a calcium carbonate suspension. The liquid mixtures containing the IR absorbing and scattering material are loaded onto the samples either by soaking or by spraying. The soaking is performed by pouring 240 ml of one of the liquid mixtures onto each sample and soaking the sample. The spraying is performed by using a spray bottle to spray 120 ml of one of the liquid mixtures onto each sample. The apparent thermal conductivity of each of the samples is measured before and after the IR absorbing material is added. The apparent thermal conductivities are shown in Table 1.

TABLE 1

| | | | | | Apparent thermal | Reduction in apparent |
|---|---|---|---|---|---|---|
| | | | | IRM* added | conductivity** | thermal conductivity |
| | | | | to fiberglass | before addition | through the addition |
| | Fiberglass | IRM* or ground | Application | vs virgin sample | of IRM* or ground | of IRM* or ground |
| Sample | density (kg/m³) | glass powder | Method | weight (wt %) | glass powder | glass powder |
| 1 | 8.71 | CaCO₃ | Soaking | 5.5% | 43.01 | 1.9% |
| 2 | 10.5 | CaCO₃ | Soaking | 13.3% | 41.26 | 2.2% |
| 3 | 7.02 | CaCO₃ | Soaking | 14.9% | 47.72 | 3.0% |
| 4 | 8.38 | CaCO₃ | Soaking | 23.0% | 44.23 | 4.9% |
| 5 | 9.12 | CaCO₃ | Soaking | 48% | 42.96 | 5.8% |
| 6 | 10.6 | Ground | Soaking | 24% | 40.74 | 2.5% |
| | | glass, same | | | | |
| | | composition | | | | |
| | | as the glass | | | | |
| | | fiber | | | | |
| 7 | 6.76 | Borax | Spraying | 3.1% | 49.14 | 0.6% |
| 8 | 7.27 | Borax | Soaking | 8.6% | 47.64 | 1.7% |

*IRM = infrared absorbing and scattering material
**Thermal conductivity units = (mW/m · ° C.) tested by ASTM C518 test method at 24° C. mean temperature

Table 1 shows that the addition of borax or calcium carbonate to FIBERGLASS results in a reduction in the apparent thermal conductivity of the insulation. For the samples with calcium carbonate, the percentage reduction in thermal conductivity is roughly proportional to the percentage of calcium carbonate applied to the FIBERGLASS.

Comparative samples showing the reduction in apparent thermal conductivity produced by adding glass fiber to insulation are provided by standard R11, R13 and R15 FIBERGLASS insulation, as shown in Table 2.

TABLE 2

| | | Added glass | Apparent thermal | Reduction in |
|---|---|---|---|---|
| | | fiber rela- | conductivity** | thermal |
| R-Value at | | tive to | before the | conductivity |
| 8.9 cm | Density | R11 | addition | through addition |
| Thick | (kg/m³) | (wt %) | of glass fiber | of glass fiber (%) |
| R11 | 8.59 | — | 45.88 | — |
| R13 | 12.8 | 49.3 | 38.82 | 15.4 |
| R15 | 22.4 | 160.6 | 33.64 | 26.7 |

**Thermal conductivity units = (mW/m · ° C.) tested by ASTM C518 test method at 24° C. mean temperature

### Example 2

Two sets of FIBERGLASS samples of varying compositions in a fiberglass insulation manufacturing process are prepared. The first set of samples is maintained as a reference. To the second set of samples is added 12 wt % calcium carbonate. The apparent thermal conductivity at 24° C. mean temperature of each sample as a function of density is determined by ASTM test procedure C518 and shown in Table 4.

TABLE 3

| Fiber- | Apparent thermal | Apparent thermal |
|---|---|---|
| glass | conductivity** | conductivity** standard |
| Density | standard | product with |
| kg/m³ | product | 12 wt % CaCO₃ |
| 8.01 | 47.41 | 48.09 |
| 8.97 | 45.16 | 45.75 |
| 11.2 | 41.41 | 41.90 |
| 12.6 | 39.83 | 40.26 |
| 12.8 | 39.57 | 39.99 |
| 14.4 | 38.18 | 38.56 |

**Thermal conductivity units = (mW/m · ° C.) tested by ASTM C518 test method at 24° C. mean temperature

Using the data in Table 3, the reduction in apparent thermal conductivity resulting from the addition of calcium carbonate is compared with the reduction in apparent thermal conductivity resulting from an increase in glass density in the FIBERGLASS insulation. The results are shown in Table 4.

TABLE 4

| | Reduction in | Reduction in | Reduction in |
|---|---|---|---|
| Range over which | apparent thermal | apparent thermal | apparent thermal |
| glass density | conductivity** from | conductivity** from | conductivity** by |
| (kg/m³) | 12% increase in | 12 wt % addition of | CaCO₃ compared |
| increased 12% | glass fiber density | CaCO₃ | to glass fiber |
| From 8.01 to 8.97 | 4.7% | 3.5% | 74% |
| From 11.2 to 12.6 | 3.8% | 2.8% | 74% |
| From 12.8 to 14.4 | 3.5% | 2.5% | 71% |

**Thermal conductivity = (mW/m · ° C.) tested by ASTM C518 test method at 24° C. mean temperature

Table 4 shows that the addition of 12 wt % calcium carbonate to FIBERGLASS is approximately 73% as effective as a 12% increase in FIBERGLASS density in reducing the apparent thermal conductivity of FIBERGLASS thermal insulation. Thus, about 1.37 (=1/0.73) times as much calcium carbonate as glass fiber must be added to achieve the same reduction in apparent thermal conductivity.

However, the cost of calcium carbonate can be less than 50% of the cost of glass fiber. Thus, the cost for reducing the thermal conductivity of FIBERGLASS insulation with calcium carbonate can be 68% (=(100)(1.37)(0.50)) or less than that of the cost of the same thermal conductivity reduction with glass fiber. Thus, calcium carbonate is a more cost-effective additive to FIBERGLASS than glass fiber for reducing the apparent thermal conductivity of the thermal insulation.

### Example 3

A fiberglass insulation sample with 12 wt % calcium carbonate is prepared in a fiberglass manufacturing process. Table 5 shows the reduction in apparent thermal conductivity at various temperatures compared to a fiberglass insulation sample with no calcium carbonate.

TABLE 5

| Apparent thermal | | Reduction in apparent |
|---|---|---|
| conductivity** | Reduction in apparent | thermal conductivity** |
| test temperature | thermal conductivity** | by CaCO₃ compared to a |
| (product density = | from 12 wt % | 12 wt % weight increase |
| 24 kg/m³) | addition of CaCO₃ | with glass fiber |
| 10° C. | 0.6% | 24% |
| 50° C. | 4.6% | 132% |
| 400° C. | 19.2% | 233% |

**Thermal conductivity units = (mW/m · ° C.) tested by ASTM C518 test method.

### Example 5

FIBERGLASS samples are prepared in a laboratory using hydrated alumina dispersed throughout as an IR absorbing and scattering material. The hydrated alumina is dispersed throughout the samples by spraying. The hydrated alumina is produced by ALCOA in the form of 1 μm particles (HYDRAL H710), 2 μm particles (HYDRAL H716), and 3.8 μm particles (B-303). The samples are 61 cm wide×61 cm long×2.5 cm thick. The apparent thermal conductivity at room temperature of each of the samples is measured before and after the hydrated alumina is added. The results are shown in Table 6.

TABLE 6

| | Fiberglass | Fiberglass | | Thermal | Thermal | |
|---|---|---|---|---|---|---|
| | density | density | | conductivity** | conductivity** | Reduction |
| | without IRM* | with IRM* | IRM* added | before addition | after addition | in thermal |
| IRM* | (kg/m³) | (kg/m³) | (wt %) | of IRM* | of IRM* | conductivity** |
| HYDRAL H716 (2 μm) | 9.19 | 9.57 | 4.22% | 42.62 | 42.06 | −1.32% |
| ″ | 9.21 | 9.61 | 4.29% | 42.40 | 41.68 | −1.70% |
| ″ | 7.57 | 7.96 | 5.21% | 45.31 | 44.48 | −1.84% |
| ″ | 11.19 | 11.58 | 3.43% | 39.66 | 39.28 | −0.98% |
| | | | Average: 4.29% | | | Average: −1.46% |
| HYDRAL H716 (2 μm) | 10.61 | 11.38 | 7.26% | 41.24 | 40.40 | −2.03% |
| ″ | 11.18 | 11.96 | 7.02% | 40.37 | 39.62 | −1.86% |
| ″ | 9.08 | 9.87 | 8.61% | 43.15 | 42.09 | −2.47% |
| ″ | 10.60 | 11.38 | 7.39% | 40.65 | 39.72 | −2.27% |
| | | | Average: 7.57% | | | Average: −2.16% |
| HYDRAL H710 (1 μm) | 6.92 | 7.29 | 5.39% | 46.17 | 45.37 | −1.72% |
| ″ | 7.95 | 8.38 | 5.37% | 43.97 | 43.43 | −1.25% |
| ″ | 8.96 | 9.38 | 4.72% | 42.13 | 41.68 | −1.06% |
| ″ | 8.47 | 8.89 | 4.93% | 43.47 | 42.82 | −1.49% |
| | | | Average: 5.10% | | | Average: −1.38% |
| HYDRAL H710 (1 μm) | 8.97 | 9.77 | 8.82% | 42.52 | 41.22 | −3.05% |
| ″ | 6.96 | 7.75 | 11.39% | 48.41 | 46.73 | −3.48% |
| ″ | 7.90 | 8.68 | 9.90% | 44.84 | 43.74 | −2.44% |
| ″ | 10.51 | 11.31 | 7.57% | 42.35 | 41.28 | −2.52% |
| | | | Average: 9.42% | | | Average: −2.87% |
| B-303 (3.8 μm) | 10.41 | 10.80 | 3.78% | 42.06 | 41.50 | −1.34% |
| ″ | 7.00 | 7.37 | 5.36% | 47.45 | 46.60 | −1.79% |
| ″ | 7.90 | 8.29 | 5.00% | 45.57 | 44.71 | −1.90% |
| ″ | 9.05 | 9.43 | 4.17% | 42.85 | 42.12 | −1.72% |
| | | | Average: 4.58% | | | Average: −1.69% |
| B-303 (3.8 μm) | 8.89 | 9.63 | 8.40% | 42.66 | 41.19 | −3.45% |
| ″ | 9.35 | 10.14 | 8.38% | 40.60 | 39.85 | −1.85% |
| ″ | 10.12 | 10.89 | 7.55% | 41.08 | 40.24 | −2.04% |
| ″ | 10.78 | 11.56 | 7.16% | 40.63 | 39.87 | −1.88% |
| | | | Average: 7.87% | | | Average: −2.30% |

*IRM = infrared absorbing and scattering material
**Thermal conductivity units = (mW/m · ° C.) tested by ASTM C518 test method at 24° C. mean temperature

The results in Table 5 show that the addition of hydrated alumina particles to FIBERGLASS can reduce the room temperature thermal conductivity of the FIBERGLASS and thus improve the insulation properties of FIBERGLASS.

The thermal conductivity of FIBERGLASS samples with and without dispersed hydrated alumina in the form of 1 μm particles (HYDRAL H710) is measured at 300° C. The results are shown in Table 7. The data represents averaged values from eight samples having identical dimensions. One set of averaged values is from four of the samples containing dispersed hydrated alumina. The other set of averaged values is from four reference samples that do not include hydrated alumina particles.

TABLE 7

| | Density | Temperature | Thermal |
|---|---|---|---|
| | (kg/m³) | (° C.) | conductivity** |
| Reference | 11.8 | 300 | 206.9 |
| Fiberglass with | 11.7 | 300 | 202.6 |
| 9.4 wt % | | | |
| Hydral H710 (1 μm) | | | |

**Thermal conductivity units = (mW/m · ° C.) tested by the ISO 8302 (equivalent to ASTM C 177-85) test method at 300° C. mean temperature

Table 7 shows that show that the addition of hydrated alumina particles to FIBERGLASS can reduce the 300° C. thermal conductivity of the FIBERGLASS by about 2.1% and thus improve the high temperature insulation properties of the FIBERGLASS.

The disclosure of the priority document, U.S. application Ser. No. 09/858,471, filed May 17, 2001, is incorporated by reference herein in its entirety.

While the present invention has been described with respect to specific embodiments, it is not confined to the specific details set forth, but includes various changes and modifications that may suggest themselves to those skilled in the art, all falling within the scope of the invention as defined by the following claims.

1-15. (canceled)

16: A method of forming a thermal insulation product, the method comprising dispersing on fibers an infrared absorbing and scattering material comprising at least one compound selected from the group consisting of carbonate compounds, borate compounds, and alumina compounds; and
forming the fibers into a porous structure.

17: The method according to claim 16, wherein the infrared absorbing and scattering material comprises calcium carbonate.

18: The method according to claim 16, wherein the dispersing comprises soaking or spraying the fibers with a liquid mixture containing the infrared absorbing and scattering material.

19: The method according to claim 18, wherein the infrared absorbing and scattering material is suspended in the liquid mixture.

20: The method according to claim 16, wherein the infrared absorbing and scattering material is dispersed on the fibers after the fibers are formed into the porous structure.

21: The method according to claim 16, wherein the dispersing comprises mixing the infrared absorbing and scattering material and the fibers.

22: The method according to claim 16, wherein the dispersing comprises
mixing the infrared absorbing and scattering material and the fibers;
heating the infrared absorbing and scattering material; and
binding the fibers together with the infrared absorbing and scattering material.

23: The method according to claim 16, wherein the mixing comprises sucking or blowing a dry powder of the infrared absorbing and scattering material into the porous structure.

24: The method according to claim 16, wherein the dispersing comprises mixing the infrared absorbing and scattering material, the fibers, and a binder.

25: The method according to claim 16, wherein the dispersing comprises
mixing the infrared absorbing and scattering material and the fibers with a binder;
heating the binder; and
binding the fibers and the infrared absorbing and scattering material together with the binder.

26: The method according to claim 25, wherein the mixing comprises sucking or blowing the binder and a dry powder of the infrared absorbing and scattering material into the porous structure.

27: The method according to claim 16, wherein the porous structure is nonwoven.

28: The method according to claim 16, wherein the fibers are inorganic.

29: The method according to claim 16, wherein the fibers comprise a glass.

30: The method according to claim 16, wherein the infrared absorbing and scattering material comprises a compound selected from the group consisting of carbonate compounds and alumina compounds.

31: The method according to claim 16, further comprising forming the porous structure into a pipe section comprising the infrared absorbing and scattering material and the fibers.

32: The method according to claim 31, wherein the infrared absorbing and scattering material is dispersed on the fibers before the porous structure is formed into the pipe section.

33: A thermal insulation product, comprising:
loose unbonded fibers; and
an infrared absorbing and scattering material dispersed on the fibers,
wherein the infrared absorbing and scattering material comprises at least one compound selected from the group consisting of carbonate compounds, borate compounds, and alumina compounds;
the infrared absorbing and scattering material has a particle size of less than 4 μm; and
the product has a porous structure.

34. The product according to claim 33, wherein at least a portion of the infrared absorbing and scattering material is dispersed on fibers inside the thermal insulation product.

35: The product according to claim 33, wherein the porous structure is nonwoven.

36: The product according to claim 33, wherein the fibers are inorganic.

37: The product according to claim 33, wherein the fibers comprise a glass.

38: The product according to claim 33, wherein the product comprises the infrared absorbing and scattering material in an amount of from 1 to 40% by weight.

39: The product according to claim 33, wherein the infrared absorbing and scattering material comprises a carbonate compound selected from the group consisting of calcium carbonate, dolomite and magnesite.

40: The product according to claim 33, wherein the infrared absorbing and scattering material comprises a borate compound selected from the group consisting of borax and colemanite.

41: The product according to claim 33, wherein the infrared absorbing and scattering material comprises hydrated alumina.

42: The product according to claim 33, further comprising a binder selected from the group consisting of thermosetting polymers, thermoplastic polymers, and inorganic compounds.

43: The product according to claim 33, wherein the infrared absorbing and scattering material absorbs infrared radiation having a wavelength in a range of 4 to 40 μm.

44: The product according to claim 43, wherein the infrared absorbing and scattering material absorbs infrared radiation having a wavelength in a range of 6 to 8 μm.

45: The product according to claim 33, wherein the infrared absorbing and scattering material has a particle size of from 1 to 3.8 μm.

46: The product according to claim 33, wherein 99% of the particles have a particle size of less than 10 μm.

47: The product according to claim 33, wherein the fibers are in the form of fiberglass having a density of from 8.01 to 22.4 kg/m³.

48: The product according to claim 33, wherein the infrared absorbing and scattering material is in direct contact with the fibers.

49: The product according to claim 33, wherein the infrared absorbing and scattering material is in contact with only the fibers.

50: The product according to claim 33, wherein the fibers are in the form of fiberglass having a density of from 8.01 to 14.4 kg/m³.

51: A thermal insulation product, comprising:
fibers; and
an infrared absorbing and scattering material dispersed on the fibers;
wherein the infrared absorbing and scattering material comprises at least one compound selected from the group consisting of carbonate compounds, borate compounds, and alumina compounds;
the infrared absorbing and scattering material has a particle size of less than 4 μm; and
the thermal insulation product has a porous structure comprising loose unbonded fibers.
